(19) United States
(12) Patent Application Publication
(10) Pub. No.: US 2026/0269256 A1
(43) Pub. Date: Sep. 10, 2026

(54) ENERGY STORAGE DEVICES WITH SWELLABLE ELECTRODES

(71) Applicant: NANORAMIC, INC., Woburn, MA (US)

(72) Inventor: Ji CHEN, Massachusetts, MA (US)

(21) Appl. No.: 19/165,904

(22) PCT Filed: Mar. 15, 2024
(86) PCT No.: PCT/US2024/020041

§ 371 Date: Sep. 16, 2025

Related U.S. Application Data
(60) Provisional application No. 63/452,831, filed on Mar. 17, 2023.

(51) Int. Cl. H01M 4/62; H01G 11/24; H01G 11/28; H01M 4/02; H01M 4/139; H01M 10/0525

(52) U.S. Cl. CPC H01M 4/622; H01G 11/24; H01G 11/28; H01M 4/139; H01M 4/625; H01M 10/0525; H01M 2004/021

(57) ABSTRACT

An energy storage device comprising two electrodes, and a separator located between and electrically separating the two electrodes wherein at least one of the electrodes comprises an active layer that comprises electrode active particles, an electrically conductive element, and an electrolyte. The active layer is characterized by one or more of the following: the volume of the active layer in the presence of the electrolyte is at least 10%, preferably at least 20%, larger than a volume of a combination of the electrode active particles and the electrically conductive element in the absence of the electrolyte; a volume during use at least 10%, preferably at least 20%, larger than an original volume; the electrically conductive element is in the form of a flexible network capable of expansion and/or compression; the active layer includes flexible binder which facilitates expansion and contraction of the active layer.

### CROSS REFERENCE TO RELATED APPLICATIONS

This application claims the benefit of U.S. Application No. 63/452,831, filed on Mar. 17, 2023, which is incorporated herein by reference in its entirety.

### FIELD OF THE INVENTION

This invention relates to an energy storage device, particularly ultracapacitors and lithium ion batteries, and to the electrodes used therein.

### BACKGROUND OF THE INVENTION

Lithium batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) comprise an anode, a cathode, and an electrolyte material such as an organic solvent comprising a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

A problem experienced in some batteries is that the electrode material can expand and contract during charging and discharging. This can lead to degradation of the performance of the battery. Swelling of the electrode is then generally suggested to be avoided.

Thus, it has been suggested that use of a combination of two binders having different glass transition temperatures and different degrees of swelling in the electrolysis solution can reduce swelling of an electrode from charging and discharging. See, U.S. Pat. No. 10,566,627.

### SUMMARY OF THE INVENTION

Disclosed herein in a first embodiment is an energy storage device comprising an electrolyte, two electrodes, and a separator located between the two electrodes, wherein at least one of the two electrodes comprises an active layer that comprises active particles interspersed in a network of carbon nanotubes, and is characterized by a volume increase during use that is at least 10%, preferably at least 20% larger than an original volume of the active layer.

Also disclosed herein is an energy storage device comprising two electrodes, and a separator located between and electrically separating the two electrodes. At least one of the electrodes comprises an active layer that comprises electrode active particles, an electrically conductive element, and a first electrolyte and is characterized by one or more of the following: the volume of the active layer in the presence of the electrolyte is at least 10%, preferably at least 20%, larger than a volume of a combination of the electrode active particles and the electrically conductive element in the absence of the electrolyte; the electrically conductive element is in the form of a flexible network capable of expansion and/or compression; the active layer includes flexible binder which facilitates expansion and contraction of the active layer.

Also disclosed herein is a method of making the energy storage device comprising providing a slurry comprising first electrically conductive elements, first electrode active material, in a liquid, forming a film of the slurry, and drying to remove the liquid to form a first electrode active layer precursor. The energy storage device is manufactured by placing the first electrode active layer precursor adjacent to a first side of a separator, placing a second electrode adjacent to an opposite side of the separator from the first side, providing a first electrolyte to the first electrode active layer precursor to form a first active layer characterized by one or more of the following: the volume of the first active layer in the presence of the first electrolyte is at least 20% larger than a volume of a combination of the first electrode active particles and the first electrically conductive element in the absence of the first electrolyte; the first electrically conductive elements are in the form of a flexible network capable of expansion and/or compression; the active layer includes an optional flexible binder which facilitates expansion and contraction of the active layer.

### BRIEF DESCRIPTION OF THE DRAWINGS

Referring now to the figures, which are exemplary embodiments, and wherein the like elements are numbered alike.

FIG. 1 is a cross-section of an example of an energy storage device as disclosed herein.

FIG. 2a is a cross-section of an energy storage device as disclosed herein showing the energy storage device before expansion of the active layer. FIG. 2b is a cross-section of an energy storage device as disclosed herein showing the energy storage device after expansion of the active layer.

FIG. 3 is a schematic of a portion of an active layer as disclosed herein.

### DETAILED DESCRIPTION OF THE INVENTION

While swelling of electrodes in lithium ion energy storage devices such as batteries and/or ultracapacitors has been generally taught to be a problem to be avoided, the present invention is based on the intentional and controlled expansion and/or compression of an electrode active layer. This expansion and/or compression can provide one or more of the following benefits: ensuring good contact between the active layer of an electrode and a current collector, ensuring good contact between the active layer of an electrode and the separator (or in some embodiments a solid state electrolyte), providing a flexible (e.g., compressible and/or expandable) electrode structure that better tolerates roughness on the separator (or solid state electrolyte) and/or electrodes and/or better tolerates changes in sizes of individual components of the electrode or the formation of gasses in the energy storage device during use.

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The energy storage device can comprise a housing that holding the electrodes (an anode and a cathode), the separator between the electrodes preventing direct electrical contact of the anode with the cathode, and an electrolyte for each electrode.

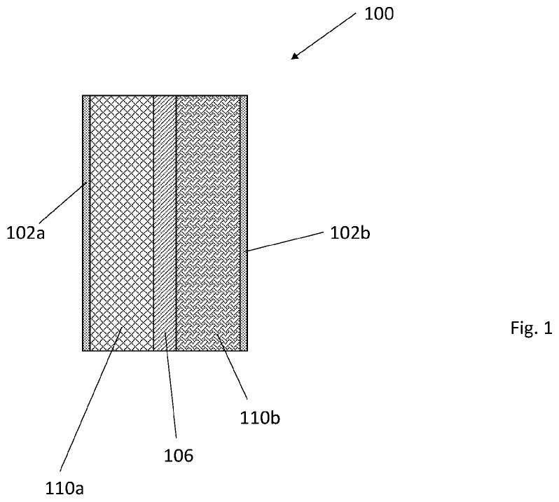

As shown in FIG. 1, an example of a battery 100 (which represents the energy storage devices disclosed herein) includes a separator 106, a first active layer 110a adjacent to a first side of the separator 106, a second active layer 110b adjacent a second side of the separator 106. The battery can also comprise a first current collector 102a and/or a second current collector 102b, adjacent to the first active layer 110a and the second active layer 110b, respectively.

The current collector 102a, 102b can comprise a metal (e.g., substantially pure metal or a metal alloy, etc.) For example, a current collector can be in the form of a metal strip or metal foil, such as an aluminum foil or strip, an aluminum alloy foil or strip, a copper foil or strip, or a copper alloy foil or strip. The current collector can have a thickness of no greater than 15 μm (microns), no greater than 10 μm, no greater than 8 μm or no greater than 5 μm. In some embodiments, at the same time the current collector can have a thickness of at least 3 μm. For example, the current collector 102 can have a thickness of 3 to 15 μm, or 6 μm and about 8 μm. As another example, current collector 102 is an aluminum foil or an aluminum alloy foil, having a thickness a thickness of 5 to 7 μm.

Either the first electrode, the second electrode, or both comprises an active layer expands and/or contract as described herein.

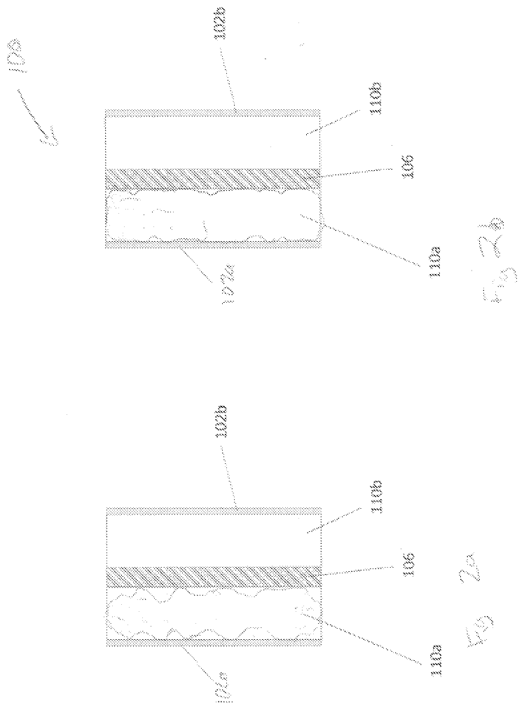

The volume of the active layer can expand in the presence of the electrolyte and/or can expand during use. For example, the volume of the active layer in the presence of the electrolyte, during use, or both is at least 10%, or at least 20%, or at least 30% and up to 60% or 50% larger than a volume of a combination of the electrode active particles and the electrically conductive element in the absence of the electrolyte and/or before use. FIG. 2a shows an active layer 110a before expansion. There are few contacts between the active layer 110a and the collector 102a and between the active layer 110a and the separator 106. In contrast, after swelling as in FIG. 2b, there are many good contacts between the active layer 110a and both the collector 102a and between the active layer 110a and the separator 106.

As another example, the active layer can be compliant (i.e., capable of expansion, compression or other changes in shape in response to forces). For example, at least one of the electrodes can comprise the electrically conductive element in the form of a flexible network that is capable of movement. Thus, as other components of the battery may expand (e.g., gas may form from reaction) the flexible network can move to accommodate the space taken by the other components. For example, the flexible network can move or compress as other components expand. In addition, the flexible network can expand in the absence of pressure such that the active layer more completely fills a space between an electrical collector and the separator.

As another example, the active layer can include a flexible binder which while holding the active particles and the electrically conductive element(s) to form a linked structure making up the active layer, the flexibility of the binder enables movement of the other components (particularly the electrically conductive elements) that facilitate movement (expansion or compression).

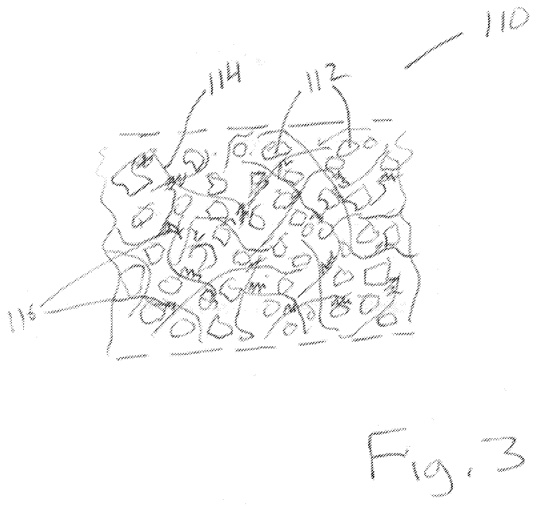

FIG. 3 shows an example of an active layer 110 as disclosed herein, comprising active particles 112 interspersed among electrically conductive elements 114 that are in the form a network. Binder 116 can be added to hold the elements in place. A flexible binder is preferred. For example, the binder can be elastomeric, or the binder can be a foamed structure.

In an embodiment, the flexible binders are preferably elastomers. In another embodiment, the flexible binder may comprise a polymer that swells but does not completely dissolve in the electrolyte. Examples of elastomers are polysiloxanes, polybutadienes, polyisoprenes, styrene-butadiene rubber, poly(styrene)-block-poly(butadiene), poly(acrylonitrile)-block-poly(styrene)-block-poly(butadiene) (ABS), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), ethylene-vinyl acetate elastomers, or the like, or a combination thereof.

Examples of polymers include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

The electrically conductive elements 114 can be separate elements that contact each other as shown in FIG. 3 to form the network or could be in the form of a mesh or web. The electrically conductive elements comprise as electrically conductive material. For example, the electrically conductive elements can comprise carbon or a metal.

For example, if the electrically conductive elements are separate but contacting elements, they can comprise high aspect ratio elements, preferably high aspect ratio carbon elements. The term “high aspect ratio elements” refers to elements having a size in one or more dimensions (the “major dimension(s)”) significantly larger than the size of the element in a transverse dimension (the “minor dimension”). High aspect ratio carbon elements can comprise a substantially cylindrical network of carbon atoms. The electrically conductive material can comprise carbon nanotubes or a plurality of bundles of carbon nanotubes.

The network can be a percolating network that can transmit an electrical current between any two separated points located on a surface of the solid active layer (without the solvent or electrolyte in it). In other words, an electrical current can be transmitted from one surface or end to an opposing surface or end of the active layer by virtue of physical contacts or electron hopping between the electrically conductive elements in the electrode active layer. The percolating network can comprise voids between the high aspect ratio carbon elements that can contain or house the electrode active materials. The high aspect ratio electrically conductive material can be substantially oriented in the electrode active layer 110 in a direction substantially parallel to the current collector to facilitate conducting electrical current from one end of the electrode to the other while still maintaining some lesser orientation through the thickness of the active layer.

The network can be flexible enabling movement of portions of the network to compensate for expansion of other components of the active layer or to expand in the absence of pressure to improve contact with the separator and, if used, with the current collector. In one example the network can have characteristics of a spring enabling compression and expansion of the active layer.

The electrically conductive material can be present in the mixture in amounts of 0.1 to 1.3, or 0.15 to 1.2, or 0.3 to 1 weight percent, based on the total weight of the mixture (the mixture comprises the electrically conductive material, the electrode active material, the binder material and a solvent). The electrically conductive material can be present in the active layer in amounts of 0.2 to 3.5, or 0.3 to 3, or 0.5 to 2 weight percent based on total weight of solids in the active layer (total weight solids comprises electrically conductive material, the binder material, the electrode active material without the solvent).

The high aspect ratio carbon elements can be single wall carbon nanotubes (SWCNTs), multiwall carbon nanotubes (MWNTs), or a mixture of both.

The single wall carbon nanotubes can have an outer diameter of 0.5 to 5.0 nanometers, preferably 1.0 to 3.5 nanometers. The single wall carbon nanotubes can have an aspect ratio (length to diameter ratio) greater than about 2.0, preferably greater than 5.0, preferably greater than 10.0, greater than 50 and more preferably greater than 100. In an exemplary embodiment, the single wall carbon nanotubes can have an average aspect ratio of 5 to 200.

The single wall carbon nanotubes can have a length greater than 6 nanometers, preferably greater than 10 nanometers, preferably greater than 15 nanometers, preferably greater than 30 nanometers, preferably greater than 50 nanometers, more preferably greater than 100 nanometers, preferably greater than 1 micrometer, preferably greater than 5 micrometers, preferably greater than 10 micrometers, and more preferably greater than 15 micrometers up to at least 200 micrometers. In an exemplary embodiment, the single wall carbon nanotubes can have an average length of 10 nanometers to 20 micrometers, preferably 20 nanometers to 15 micrometers.

The single wall carbon nanotubes can be present in the mixture of electrically conductive material, binder material, electrode active material and solvent in an amount of 0.1 to 2 weight percent based on the total weight of the mixture. For example, the amount of single wall nanotubes in the mixture can be 0.1 to 0.3, or 0.15 to 9.25 weight percent. As another example, the amount of single wall nanotube in the mixture can be 0.4 to 2 weight percent.

The single wall carbon nanotubes can be present in the electrode active layer (electrically conductive material, binder material, and electrode active material without the solvent) in an amount of 0.2 to 4 weight percent (wt %), based on the entire weight of the electrode active layer. For example, the amount of single wall nanotubes in the electrode active layer can be 0.2 to 0.6, or 0.3 to 0.5 weight percent. As another example, the amount of single wall nanotube in the electrode active layer can be 0.5 to 4 weight percent.

The number of carbon walls in the multi-wall carbon nanotubes can be 2 or more, 5 or more, 10 or more, 50 or more. The multi-wall carbon nanotubes can comprise an average of between 3 layers to 15 layers, 4 to 12 layer, 5 to 10 layers, 6 to 8 layers.

The active layer 110 can comprise multi-wall carbon nanotubes and single-wall carbon nanotubes. A layer comprising the multi-wall carbon nanotubes swells more than a layer comprising only single-wall carbon nanotubes when wetted with an electrolyte in an energy storage device in which electrode 100 is located. For example, the layer having the multi-wall carbon nanotubes can swell at least 15%, or at least 25% or at least 50% more than single-wall carbon nanotubes when wetted with an electrolyte in an energy storage device in which electrode 100 is located. For example, a length of the multi-wall carbon nanotubes can expand at least 15%, or at least 25% or at least 50% more than a length of the single-wall carbon nanotubes when wetted with the electrolyte. As another example, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

The multi-wall carbon nanotubes can have an outer diameter of 2.0 to 50 nanometers, 5.0 to 40 nanometers, or 6 to 10 nanometers. The multi-wall carbon nanotubes can have a length greater than 10 nanometers, greater than 15 nanometers, greater than 30 nanometers, greater than 50 nanometers, greater than 100 nanometers, greater than 500 nanometers, greater than 1 micrometer, greater than 5 micrometers, greater than 10 micrometers, or greater than 15 micrometers. At the same time, the multi-wall carbon nanotubes can have an average length up to 25 micrometers or up to 20 micrometers. In exemplary embodiments, the multi-wall carbon nanotubes have an average length of 10 nanometers to 20 micrometers, or 20 nanometers to 15 micrometers. The multi-wall carbon nanotubes can have an aspect ratio (length to diameter ratio) greater than 5.0, greater than 10.0, greater than 50, greater than 100, or greater than 500.

The electrode comprises multi-wall carbon nanotubes that can be relatively longer in comparison to multi-wall carbon nanotubes comprised in related art electrodes. The use of relatively longer multi-wall carbon nanotubes in electrodes is found to have beneficial mechanical and/or electrical properties. For example, multi-wall carbon nanotubes provide relatively good power at low densities. As another example, shorter multiwall carbon nanotubes generally do not swell (e.g., expand) as much as longer multiwall carbon nanotubes. As such use of shorter multi-wall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multi-wall carbon nanotubes. An indication that a length of a certain amount of multi-wall carbon nanotubes have a length exceeding a threshold length and thus have sufficient swelling properties is an observation during a calendaring process—a relatively larger amount of pressure or effort to calendar the slurry in connection with applying to the foil is indicative that the collective swelling (e.g., an average swelling) of the multi-wall carbon nanotubes in the active layer will satisfy a certain performance threshold. However, multi-wall carbon nanotubes are generally difficult to process.

The processing of the multi-wall carbon nanotubes in connection with preparing/forming the active layer and/or electrode is gentler than processes for related art electrodes. As such, the processes according to various embodiments maintain longer multi-wall carbon nanotubes (e.g., less multi-wall carbon nanotubes are crushed, fragmented, broken, etc.). In some embodiments, the active layer of the electrode comprises a set of multiwall carbon nanotubes having an average length that is more an average length of the multiwall carbon nanotubes in related art electrodes. According to various embodiments, a distribution of lengths of the set of multi-wall carbon nanotubes is skewed towards a nominal length a multi-wall carbon nanotube. As an example, the nominal length of a multi-wall carbon nanotube is about 16 microns. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length. In some embodiments, at least 75% of the multi-wall carbon nanotubes within the network of high aspect ratio carbon elements are within 10% of the nominal length (e.g., between 13.4 microns to about 15 microns). In some embodiments, at least 75% of the multi-wall carbon nanotubes within the network of high aspect ratio carbon elements have a length of at least 12 microns. In some embodiments, at least 75% of the multiwall carbon nanotubes within the network of high aspect ratio carbon elements have a length of at least 13 microns. In some embodiments, at least 50% of the multi-wall carbon nanotubes within the network of high aspect ratio carbon elements are within 10% of the nominal length (e.g., between 13.4 microns to about 15 microns). In some embodiments, at least 50% of the multi-wall carbon nanotubes within the network of high aspect ratio carbon elements have a length of at least 12 microns. In some embodiments, at least 50% of the multiwall carbon nanotubes within the network of high aspect ratio carbon elements have a length of at least 8 microns. In some embodiments, at least 50% of the multi-wall carbon nanotubes within the network of high aspect ratio carbon elements have a length of at least 13 microns.

According to various embodiments, a distribution of lengths of the set of multi-wall carbon nanotubes is skewed towards a nominal length a multi-wall carbon nanotube. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length.

In some embodiments, at least 75% of the multiwall carbon nanotubes within the network of high aspect ratio carbon elements are within 10% of the nominal length (e.g., between 13.4 micrometers to about 15 micrometers). In some embodiments, at least 75% of the multi-wall carbon nanotubes within the network of high aspect ratio carbon elements have a length of at least 12 micrometers. In some embodiments, at least 75% of the multi-wall carbon nanotubes within the network of high aspect ratio carbon elements have a length of at least 13 micrometers. In some embodiments, at least 50% of the multi-wall carbon nanotubes within the network of high aspect ratio carbon elements are within 10% of the nominal length (e.g., between 13.4 micrometers to about 15 micrometers). In some embodiments, at least 50% of the multi-wall carbon nanotubes within the network of high aspect ratio carbon elements have a length of at least 12 micrometers. In some embodiments, at least 50% of the multiwall carbon nanotubes within the network of high aspect ratio carbon elements have a length of at least 13 micrometers.

The multi-wall carbon nanotubes can be present in the mixture (the mixture comprises the electrically conductive material, the electrode active material, the binder material and a solvent) in an amount of 0.3 to 1.0 weight percent, preferably 0.4 to 0.9 weight percent based on the total weight of the mixture. The multi-wall carbon nanotubes are present in the solid anode active layer (the solid active layer comprises the electrically conductive material, the binder material, the electrode active material without the solvent) in an amount of 0.8 to 2.6 wt %, preferably 1.0 to 1.8 wt %, based on the entire weight of the solid anode active material.

In an example where both multi-wall and single wall carbon nanotubes are used, the ratio of the weight of the multi-wall carbon nanotubes to the weight of the single wall carbon nanotubes in the mixture or in the solid active material layer can be at least 2:1.

In one example, three-dimensional network of high aspect ratio carbon elements 108 comprises carbon nanotubes, and the carbon nanotubes are only multi-wall carbon nanotubes and/or fragments of such carbon nanotubes.

In another example, the multiwall carbon nanotubes are present in the mixture or in the solid anode active material layer in an amount that is at least twice the amount of the single wall carbon nanotubes, based on the weight of the conductive materials.

The network of three-dimensional network of high aspect ratio carbon elements 108 can comprise at least 99% carbon by weight.

The three-dimensional network of high aspect ratio carbon elements 108 can comprise an electrically interconnected network of carbon elements exhibiting connectivity above a percolation threshold and wherein the network defines one or more highly electrically conductive pathways having a length greater than 100 μm. The percolation threshold is one where the conducting elements contact one another to provide an electrically conducting network measured across any two points on any surface of the network.

The active layer includes an active particle dispersed among the network of electrically conducting elements. The active particles comprise active material. The active material typically will be different for an anode than for a cathode.

For example, the anode active material can comprise silicon (Si), germanium (Ge), tin (Sn), lead (Pb), antimony (Sb), bismuth (Bi), zinc (Zn), aluminum (Al), titanium (Ti), nickel (Ni), cobalt (Co), cadmium (Cd); alloys or two or more thereof or alloys thereof with other elements; oxides, carbides, nitrides, sulfides, phosphides, selenides, and tellurides of those metals and their mixtures or lithium-containing composites; salts and hydroxides of Sn; lithium titanate, lithium manganate, lithium aluminate, lithium-containing titanium oxide, lithium transition metal oxide; prelithiated versions thereof; particles of Li, Li alloy, or surface stabilized Li having at least 60% by weight of lithium; or combinations thereof. The active material can comprise graphite in lieu of or in addition to the anode active material. As one example, the anode active material can comprise a silicon oxide and/or carbon silicon oxide. Such anode active material comprising a silicon oxide or carbon silicon oxide can further comprise graphite.

For example, the cathode active material can comprise a lithium cobalt oxide (LCO, sometimes called “lithium cobaltate” or “lithium cobaltite”). Examples of LCO formulations include LiCoO2; lithium nickel manganese cobalt oxide (NMC, with a variant formula of LiNiMnCo); lithium manganese oxide (LMO with variant formulas of LiMn₂O₄, Li₂MnO₃ or the like, or a combination thereof); lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials. Other variants of the foregoing may be included.

Where NMC is used as an active material, a nickel rich NMC may be used. For example, the variant of NMC may be LiNiₓMn_{y}Co_{(1-x-y)}O₂, where x is equal to or greater than about 0.7, 0.75, 0.80, 0.85 or more, y is equal to or greater than 0.1, 0.15, 0.2 or 0.25, and x+y is less than 1. For example, NMC811 may be used where x is about 0.8 and y is about 0.1. Alternatively, the active material can include oxides of lithium nickel manganese cobalt (LiNiₓMn_{y}Co₂O₂). Variants of this formula that may be used in the active material layer include NMC 111 (detailed below), NMC532 (LiNi_{0.5}Mn_{0.3}Co_{0.2}O₂), NMC622 (LiNi_{0.6}Mn_{0.2}Co_{0.2}O₂), or a combination thereof.

In an embodiment, the active material used in both electrodes (anode and/or cathode) may also include a nickel-rich combination of nickel, manganese, and cobalt. Lithium-Nickel-Manganese-Cobalt-Oxide (LiNiMnCoO₂), abbreviated as NMC delivers strong overall performance, excellent specific energy, and the lowest self-heating rate of all mainstream cathode powders. The NMC powder may comprise nickel in an amount of 20 to 40 wt %, manganese in an amount of 20 to 40 wt % and cobalt in an amount of 20 to 40 wt %, based on a total weight of the NMC blend. While the term “NMC powder” can refer to a variety of blends, it is desirable to use a blend that comprises 33 wt % nickel, 33 wt % manganese and 33 wt % cobalt. This blend, sometimes referred to as 1-1-1 (NMC 111) is useful for applications that use frequent cycling (automotive, energy storage) due to the reduced material cost resulting from lower cobalt content a nickel-rich combination of nickel, manganese, and cobalt (NMC). The NMC powder may comprise nickel in an amount of 20 to 40 wt %, manganese in an amount of 20 to 40 wt % and cobalt in an amount of 20 to 40 wt %, based on a total weight of the NMC blend. While the term “NMC powder” can refer to a variety of blends, it is desirable to use a blend that comprises 33 wt % nickel, 33 wt % manganese and 33 wt % cobalt. This blend, sometimes referred to as 1-1-1 is useful for applications that use frequent cycling (automotive, energy storage) due to the reduced material cost resulting from lower cobalt content. Lithium-Nickel-Manganese-Cobalt-Oxide (LiNiMnCoO2) delivers strong overall performance, excellent specific energy, and the lowest self-heating rate of all mainstream cathode powders.

As disclosed herein, the active material can be located within a network of high aspect ratio active materials present in the electrode active layer. The active material can be present in the mixture used to form the electrode in amount of 35 to 75 wt %, preferably 40 to 70 wt %, based on a total weight of the electrode mixture (the mixture used to manufacture the electrode active layer which contains the electrode polymeric binder material, the electrode active material, the electrically conducting material and the solvent). The electrode active material is present in the electrode active layer (which is devoid of the solvent) in an amount of 95 to 98.5 wt %, based on a total weight of the cathode active layer.

The active layer can also include a binder. The binder can facilitate cohesiveness of the other components of the active layer and/or can hold the active particles and the electrically conductive elements in relative position and shape. The binder can be, or can comprise as a major component, a polymer. The binder can comprise a single polymer, which can be a homopolymer or a copolymer. Since the active layer as disclosed herein is capable movement (expansion, contraction, etc.), the binder can advantageously be a flexible polymeric material, such as an elastomer or a polymer foam. As another example, the binder can be characterized by softening in the electrolyte.

The binder can also facilitate dispersion of the active particles and the electrically conducting elements (when in particulate foam) in a slurry during manufacture of the active layer. The binder can facilitate adherence of the active layer to adjacent layers in the battery. The binder can comprise, for example, a cellulosic polymer, or an acrylic polymer.

The active layer 110 as disclosed herein includes an electrolyte. The electrolyte facilitates transport of ions between the cathode and anode. The electrolyte can comprise a salt in an organic solvent. In certain instances, the organic solvent can be chosen to soften the binder. Examples of salts that can be used in the electrolyte include lithium hexafluorophosphate (LiPF₆), lithium perchlorate (LiClO₄), lithium tetrafluoroborate (LiBF₄), lithium hexafluoroarsenate (LiAsF₆), lithium hexafluorosilicate (LiSiF₆), and lithium tetraphenylborate (LiB(C₆H₅)₄). Examples of organic solvent include ethylene carbonate, diethyl carbonate, dimethyl carbonate, ethyl methyl carbonate, propylene carbonate, methyl formate, methyl acrylate, methyl butylate and ethyl acetate.

The separator 106 prevents direct electrical contact between the two electrodes but allows for passage of the ions from one electrode to the other. The separator can comprise, for example, a polymer film. As a particular example, the separator can comprise a single layer or multilayer polymer film comprising one or more polyolefin layers. For example, a film comprising a laminate of a polyethylene and a polypropylene can be used. The separator can have a rough surface and the compliance and/or expansion of the active layer as described herein can facilitate good contact between the active layer and the separator.

The energy storage device as disclosed herein can be manufactured by mixing the electrically conductive material, the electrode active material, and the optional binder with a liquid to form a slurry. The slurry can be formed into a film and dried to remove the liquid to form an electrode active layer precursor. The energy storage device can then be assembled by placing the electrode active layer precursor adjacent to a first side of a separator, placing a second electrode adjacent to the opposite side of a separator, providing a first electrolyte to the first electrode active layer precursor to form a first active layer. In an embodiment, before the electrolyte is provided the combination of electrodes and separator is placed in a housing.

When the electrode with the active layer contacts an electrolyte it expands thereby facilitating improved contact with the current collector and with the separator. This improves the conduction of electricity.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. An energy storage device comprising two electrodes, and a separator located between and electrically separating the two electrodes wherein at least one of the electrodes comprises an active layer that comprises electrode active particles, an electrically conductive element, and a first electrolyte the active layer being characterized by one or more of the following: the volume of the active layer in the presence of the electrolyte is at least 10%, preferably at least 20%, larger than a volume of a combination of the electrode active particles and the electrically conductive element in the absence of the electrolyte; the electrically conductive element is in the form of a flexible network capable of expansion and/or compression; the active layer includes flexible binder which facilitates expansion and contraction of the active layer.

2. The energy storage device of claim 1 wherein the electrically conductive element comprises a web of high aspect ratio conductive elements.

3. The energy storage device of claim 2 wherein the high aspect ratio conductive elements comprises carbon nanotubes.

4. The energy storage device of claim 1 wherein the electrically conductive element is a mesh.

5. The energy storage device of claim 4 wherein the active layer includes the flexible binder.

6. The energy storage device of claim 4 wherein the flexible binder is a foam.

7. The energy storage device of claim 4 wherein the flexible binder is softened by but does not dissolve in a solvent of the electrolyte.

8. The energy storage device of claim 7 wherein the flexible network behaves as a spring.

9. An energy storage device comprising two electrodes, and a separator located between the two electrodes, wherein at least one of the two electrodes comprises active particles, an electrically conductive element, and an electrolyte and is characterized by a volume during use at least 10%, preferably at least 20%, larger than an original volume.

10. The energy storage device of claim 9 wherein the active layer has a volume during use of 30 to 60% of the volume of an active layer precursor comprising the electrode active particles contained within a network of the electrically conductive element.

11. The energy storage device of claim 10 wherein the electrolyte comprises a salt in an organic solvent and the active layer includes a binder, wherein the binder softens but is not dissolved by the organic solvent.

12. A method of making an energy storage device comprising
providing a slurry comprising electrically conductive elements, electrode active particles, and optional binder in a liquid,
forming a film of the slurry,
drying to remove the liquid to form an electrode active layer precursor,
assembling the energy storage device by placing the electrode active layer precursor adjacent to a first side of a separator,
placing a second electrode adjacent to the opposite side of a separator,
providing an electrolyte to the electrode active layer precursor to form a first active layer.

13. The method of claim 12 wherein the electrode active precursor, the separator, and the second electrode are placed within a housing before providing the electrolyte.

14. The method of claim 12 wherein the active layer is characterized by one or more of the following: the volume of the first active layer in the presence of the first electrolyte is at least 10%, preferably at least 20%, larger than a volume of a combination of the first electrode active particles and the first electrically conductive element in the absence of the first electrolyte; the first electrically conductive elements are in the form of a flexible network capable of expansion and/or compression; the active layer includes flexible binder which facilitates expansion and contraction of the active layer.
